(19) United States
(12) Patent Application Publication
(10) Pub. No.: US 2016/0225184 A1
(43) Pub. Date: Aug. 4, 2016

(54) RECOMMENDATION ENGINE INTERFACE AND METHOD

(71) Applicant: KONINKLIJKE PHILIPS N.V., Eindhoven (NL)

(72) Inventors: ERIK VLEMMIX, EINDHOVEN (NL); MAURO BARBIERI, EINDHOVEN (NL); JOHANNES HENRICUS MARIA KORST, EINDHOVEN (NL)

(21) Appl. No.: 15/021,121

(22) PCT Filed: Sep. 10, 2014
(86) PCT No.: PCT/EP2014/069236

§ 371 Date: Mar. 10, 2016

(30) Foreign Application Priority Data
Sep. 18, 2013 (EP) 13184882.2

(51) Int. Cl. G06T 17/10; G06F 3/0488; G06F 3/0484; G06F 3/0481; G06F 3/0482

(52) U.S. Cl. CPC G06T 17/10; G06F 3/04815; G06F 3/0482; G06F 3/04842; G06F 3/0488; G06T 2200/24

(57) ABSTRACT

A recommendation engine interface is provided having an image construction unit (30) provided with respective modules to assign to each content item a respective region in a space defined by the intermediate coordinates (x,y), to assign to each region a depth value (z), that corresponds to a recommendation value for a content item to which said region is assigned, to map to each region respective image data (f(i)) of the content item to which said region is assigned, and to combine said respective image data (f(i)) and said respective depth value (d(i)) for the regions assigned to the content items in said subset into three-dimensional image data (g(x,y,z)) to be provided to a display facility (40).

### FIELD OF THE INVENTION

The invention relates to a recommendation engine interface.

The invention further relates to a method for visualizing a recommendation of content items.

### BACKGROUND OF THE INVENTION

Recommender systems are increasingly being applied to aid users in selecting content items that fit their needs or taste. A recommender system learns the taste of a user on the basis of feedback of the user on previous content items (a so-called rating history) and/or by comparing the rating histories of different users (using a collaborative filtering approach). In any case, a recommender expresses the estimated degree to which the user likes a new content item by a numerical value, for example, a real number between −1 and 1, where a −1 indicates a strong dislike, a 1 indicates a strong like, and a zero indicates a neutral. These numerical values are often called ‘like-degree’.

A recommender engine interface is disclosed by CN102722524. This document discloses a website recommendation result displaying method and a device and a terminal with the device. The website recommendation result displaying method comprises the steps of providing each recommendation result related to items according to the items selected by an user; analyzing a website recommendation model and extracting multiple attribute values of each recommendation result according to the recommendation model; establishing a multidimensional coordinate system; mapping multiple attribute values of each recommendation result to the multidimensional coordinate system; drawing a multidimensional model of each recommendation result according to the position of each recommendation result in the multidimensional coordinate system; displaying the multidimensional model of each recommendation result in the multidimensional coordinate system.

WO2011097675 discloses a method for displaying the results of a search, or identifying a specific object in a collection. Therein each object is represented using an image or icon and has associated metadata. Common metadata attributes such as colour (RGB, Brightness), creation date, title etc, between the objects are used to define a data space and each object is assigned a point in the dataspace. The dataspace is then projected down to a 3D viewing space wherein a representation or image of the object will be displayed. To improve the visualisation of the objects, the projected points are adjusted so as to reduce the clustering of points whilst maintaining or preserving the order of the points. This declustering step preserves the structural relationship between the objects while optimising the viewing volume (effectively reducing void spaces in the displayed collection) thus improving the visual representation of the collection and allowing more efficient identification and selection of an object in the collection. A recommender engine interface is disclosed by U.S. Pat. No. 7,137,075. The known recommender engine interface provides for a plurality of tangential contents display zones established for various content genres. Content items are arranged in the contents display zones respectively associated therewith. These zones extend in a direction of depth, in a radial direction, and are disposed such that the user receives an impression that a content item at a deeper position is at a larger distance from the user. In the example shown in FIG. 5 a content display zone is provided for each of fashion (FA), travel (TR), movie (MO), and usual activities (TI) for the morning and the evening. Another example is shown in FIG. 25, therein content display zones are provided for information of pleasure resort, personal computer processing, reservation and ticket issuance banking transactions and traffic information. Essentially, in the known recommender engine interface a tangential coordinate indicates the type of a content item by its placement in a content zones and a radial coordinate indicates the recommendation level. It is a disadvantage of the system known from U.S. Pat. No. 7,137,075 that it only enables a limited categorization. Increasing the number of categories may involve the tendency of objects to clutter. In particular objects having the highest recommendation level, which are displayed in the narrow part of the zones tend to clutter tend to be obscured therewith.

### SUMMARY OF THE INVENTION

It is an object of the present invention to provide a recommender engine interface that is improved by enabling a more detailed recommendation.

It is a further object of the present invention to provide a method for visualizing a recommendation of content items that is improved by enabling a more detailed recommendation.

According to a first aspect of the present invention a recommender engine interface is provided that includes

a retrieval unit to provide a list of content items and an associated recommendation value,

an image construction unit to construct an image, the image having an image value as a function of a first, a second and a third intermediary coordinate, the image constructing unit including
(a) a region assignation module to assign to at least a subset of content items in said list a respective region in a space defined by the first and the second intermediate coordinates,
(b) a depth assignation module to assign to each region a respective depth value for said third intermediary coordinate, the depth value corresponding to the recommendation value for the content item to which said region is assigned,
(c) an image mapping module to map to each region respective image data of the content item to which said region is assigned,
(d) a combination module to provide said respective image data and said respective depth value for the regions assigned to the content items in said subset as three-dimensional image data to be provided to a display facility.

Content items may include programs, data streams containing video and/or audio data and program segments as well as products and services.

The present invention enables the user viewing the visual data provided by the recommender engine interface to better perceive the mutual differences in recommendation value for the various content items and also to perceive when content items mutually have the same recommendation value. The depth value corresponds to the recommendation value in that more recommended content items appear closer to the viewer. In other words, a proximity to the viewer as defined in said depth direction is a monotically non-decreasing function of the recommendation value, the function at least having a monotonically increasing portion. The relation between the depth value and the recommendation value may be stepwise. In an embodiment the relationship between the recommendation value and the depth value is capped between a minimum and a maximum depth value.

The content items in the subset may include those content items having the highest like degree, or the items with the highest like degree, satisfying additional selection criteria. Alternatively, for example if the list only includes a limited set of content items, the second facility may construct an image for each of the content items in the list.

In a particular embodiment the image delivery unit is further provided to construct from the mapped image data and assigned depth value respective three-dimensional objects for the items in the subset. In that case the three-dimensional image data provided to the display facility represents said three-dimensional objects. It is noted that the constructed image and displayed by the display facility maybe a still image, but may alternatively be a video image.

According to a second aspect of the present invention a content delivery apparatus is provided including a recommender engine interface according to the first aspect and further including a display facility for displaying the constructed image. In a first embodiment thereof the retrieval unit is arranged to retrieve the list of content items and their associated recommendation value from an external source. In another embodiment of the content delivery apparatus the retrieval unit is arranged to retrieve the list of content items and their associated recommendation value from an internal source.

According to a third aspect of the present invention a method for visualizing a recommendation of content items is provided comprising the steps of

for each content item determining a respective recommendation value,

constructing an image having image information (g) as a function of a first, a second and a third intermediary coordinate (x,y), said constructing including,
(a) assigning to at least a subset of content items in said list a respective region in a space defined by said intermediate coordinates (x,y),
(b) assigning to each region a depth value for said third intermediary coordinate, the depth value corresponding to the recommendation value for the content item corresponding to said region,
(c) for each region mapping respective image information of the content item corresponding to said region,
(d) combine said respective image information and said respective depth value for the regions assigned to the content items in said subset into three-dimensional image data (g(x,y,z)),

displaying the constructed image.

In an embodiment the respective regions are obtained by a first partitioning and a second partitioning of space defined by the intermediary coordinates, wherein the first and the second partitioning respectively partition the space in the direction of the first and the second coordinate, respectively according to a first and a second property of the content items. In this way the user can easily locate content items having the same first property in regions having the same range according to the first coordinate and content items having the same second property in regions having the same range according to the second coordinate.

In an embodiment the display facility comprises a three-dimensional display, and the image information is displayed on the three-dimensional display as a function of the first and the second intermediary coordinate (x,y) and the depth-value (z) assigned to the region comprising the first and the second intermediary coordinate. A three-dimensional display is best suitable to present the recommendation value as depth information to the viewer. The three-dimensional display may for example be a stereo display, an auto-stereoscopic display a volumetric display or a holographic display.

A three-dimensional display may not always be available. In this case, the recommendation value can still be efficiently visualized in an embodiment wherein the display facility comprises a two-dimensional display, the display facility further comprising a display processor for projecting the three-dimensional image to a projection (h2(x,y)) from the image information (g(x,y,z)).

In particular such embodiments using a 2D-display it is attractive if the image delivery unit is further provided to construct from the mapped image data and assigned depth value respective three-dimensional objects for the items in the subset as described above.

In an embodiment the display facility in an operational mode displays a selection of the content items from the list of content items and the content delivery apparatus has a selection control facility that generates a selection control signal in response to a sensed user input indicative for a desired change in selection, wherein the selection control signal causes the display facility to change the selection in accordance with the sensed user input.

In an embodiment further a view control facility may be provided that generates a view control signal in response to a sensed user input indicative for a desired change in a perspective with which the content items are displayed, which view control signal causes the display facility to change a perspective with which the content items are displayed in accordance with the sensed user input. A view control facility is of particular relevance for embodiments having a two-dimensional display facility, as allowing the user to change the perspective makes it possible to better estimate the depth assigned to the various content items on the basis of their recommendation value.

In an embodiment content items having a neutral recommendation value are displayed in said depth dimension at a position corresponding to a surrounding frame. The surrounding frame may be a frame that is physically present, such as a rim of the display, or may be a virtual frame. This embodiment make it possible that the user not only can recognize the mutual difference in recommendation value between the various items, but also can have an indication of an absolute value of the recommendation value, and in particular recognize whether the recommendation value of a content item is positive or negative.

In an embodiment a content delivery apparatus comprises in addition to said display facility a touch panel. The touch panel is preferably a two-dimensional touch-screen display. The additional touch panel allows various additional control modes that facilitate navigation and selection. The touch panel may have swipe sensing facilities that support these control modes. For example, in this embodiment the display facility in an operational mode displays a selection of the content items from the list of content items. In this case the touch panel may have a first swipe sensing facility that serves as the selection control facility. I.e. the first swipe sensing facility generates a first swipe sense signal (as the selection control signal) in response to a sensed swiping movement in a particular direction, e.g. horizontal or vertical. This first swipe sense signal causes the display facility to change the selection in accordance with the swiping movement in that direction. This enables the user to change the selection in an intuitive way. Alternatively, the user may specify a change in selection using another input facility such as arrow buttons indicating the direction according to which the selection should be changed.

As another example in this embodiment, the touch panel may have a second swipe sensing facility that serves as the view control facility. I.e. the second swipe sensing facility generates a second swipe sense signal (as the view control signal) in response to a sensed swiping movement in a particular direction, which second swipe sense signal causes the display facility to change a perspective with which the content items are displayed in accordance with the swiping movement in that particular direction. Alternatively the user may specify a change in perspective using another input facility, such as arrow buttons.

A recommendation value for a content item may for example be based on a rating given by an authorized reviewer or an average computed from ratings given by other users. In an embodiment the recommender engine interface or an apparatus comprising the recommender engine interface, such as a content delivery apparatus further comprises a storage medium which stores a user profile, wherein the user profile comprises values associated by a user to content item features. In this case a recommender engine forming part of the recommender engine interface or the apparatus comprising the recommender engine interface can determine a recommendation value in accordance with the content item features present in the content items and the values associated therewith by the user. In this way a recommendation value can be computed that more accurately corresponds to the specific interests of the user.

### BRIEF DESCRIPTION OF THE DRAWINGS

These and other aspects of the present invention are described in more detail with reference to the drawing. Therein:

FIG. 1 schematically shows a first embodiment of a content delivery apparatus according to the second aspect of the invention, comprising a recommender engine interface according to the first aspect coupled to a display facility,

FIG. 2 shows a first part of an embodiment of a recommender engine interface according to the first aspect in more detail,

FIG. 3 shows a second embodiment of a content delivery apparatus according to the second aspect of the invention,

FIG. 4 shows a third embodiment of a content delivery apparatus according to the second aspect of the invention, show an alternative display facility therein in more detail,

FIG. 5 shows a fourth embodiment a content delivery apparatus according to the second aspect of the invention having additional control options,

FIG. 6A shows a fifth embodiment of a content delivery apparatus according to the second aspect of the invention and coupled to an external source,

FIG. 6B shows the fifth embodiment of the content delivery apparatus in more detail,

FIG. 7 shows a sixth embodiment of a content delivery apparatus according to the second aspect of the invention having an internal source for recommendation data,

FIG. 8 shows a part of the content delivery apparatus of FIG. 7 in more detail,

FIG. 9 schematically shows a method according to the third aspect of the invention,

FIGS. 10A, 10B show an application of the recommendation system and the method for recommending content items according to the present invention, therein FIG. 10A provides for a schematic illustration and FIG. 10B shows an actual implementation.

### DETAILED DESCRIPTION OF THE EMBODIMENTS

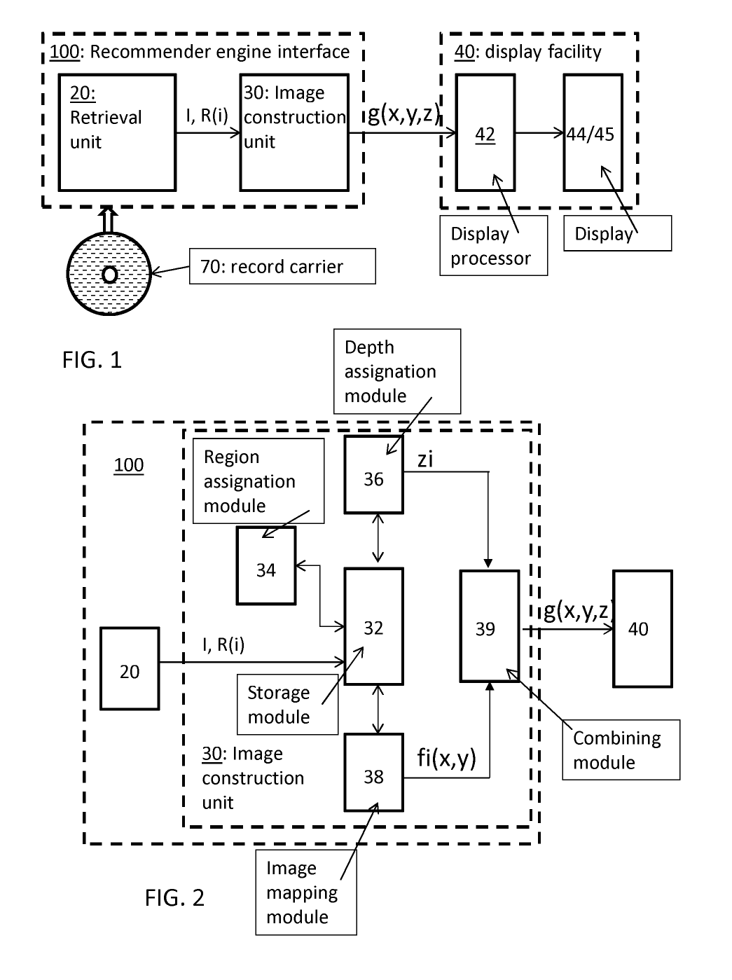

FIG. 1 schematically shows a content delivery apparatus including a recommender engine interface 100 and a display facility 40. The recommender engine interface includes a retrieval unit 20 to retrieve recommendation information R(i) including a list of content items and an associated recommendation value,

The recommender engine interface 100 also includes an image construction unit 30 to construct an image. The image to be constructed has image information (f) as well as a depth value (z) as a function of a first and a second intermediary coordinate (x,y). The display facility 40 of the content delivery apparatus includes display processor 42 and a display for displaying the constructed image, for example a two-dimensional display 44 or a three-dimensional display 45. The image information (f) may comprise for example a grey value or a set of RGB values.

The recommender engine interface 100 may be carried out as dedicated hardware, but may alternatively comprise a programmable processor. FIG. 1 further shows a computer readable medium 70 comprising a computer program, which can be executed by such a programmable processor. Likewise the display facility 40 may be fully implemented by dedicated hardware, but may alternatively comprise a programmable processor that may be programmed using a computer readable medium. Also combinations of dedicated hardware and programmable components may be used in the recommender engine interface 100 or the display facility 40.

FIG. 2 shows the image construction unit 30 in more detail. In the embodiment shown, the image construction unit 30 includes a first sub-facility 34 for assigning to each content item a respective region in a space defined by the intermediate coordinates (x,y). The regions may have arbitrary shapes. In an embodiment for example the content items to be displayed are countries on a map, and the shape of the regions corresponds to the borders of the countries. In case there is no such natural boundary it is advantageous if the regions result from a first partitioning and a second partitioning of the space are defined by the intermediary coordinates, wherein the first and the second partitioning respectively partition the space in the direction of the first and the second coordinate respectively according to a first and a second property of the content items.

The content items may for example be television programs. In that case, the first partitioning may be used to indicate the channel that offers the programs and the second partitioning may be according to the time at which a program is offered by the channel.

The image construction unit 30 also includes a depth assignation module 36 for assigning to each region a depth value. The depth value corresponds to the recommendation value for the content item to which said region is assigned. A proximity to the user as defined in said depth direction is a monotonically non decreasing function of the recommendation value, wherein the function at least has a monotonically increasing portion. Therewith content items that are more recommended to the viewer are typically closer to the viewer. It is not necessary that the relationship between the proximity and the recommendation value is linear. The relationship may for example be stepwise linear. A non-linear function may be used to better visualize the highly recommended content items. For example all items having a recommendation level below a predetermined threshold may be assigned a same, maximum depth value, i.e. most remote from the viewer.

As an additional key to the viewer, content items having a neutral recommendation value may be displayed in said depth dimension at a position corresponding to a surrounding frame. The surrounding frame may be a physical frame of the display, but may alternatively be a virtual frame displayed by the display and that surrounds the content items. As a further key to the viewer the boundaries between the regions may be indicated by a grating that has a depth value corresponding to the neutral recommendation value.

The image construction unit 30 also includes an image mapping module 38 for mapping to each region respective image information of the content item to which said region is assigned. Image information corresponding to a content item is for example a picture or a text, descriptive for the content item, e.g. a title.

In the embodiment shown a storage module 32 is provided for storage space to be used by the region assignation module 34, the depth assignation module 36 and the image mapping module 38 and for information exchange between these modules.

A combining module 39 is further provided to combine the image data fi(x,y) and said respective depth value di(x,y) for the regions assigned to the content items in said subset into three-dimensional image data g(x,y,z) to be provided to a display facility 40.

The display facility 40 may include a display processor 42 and a display screen 44, 45.

The combining module may include a storage facility wherein the 3D image data g(x,y,z) is temporarily stored. The storage facility may be addressable according to a two-dimensional coordinate system based on the intermediary coordinates x,y and may comprise addressable locations having image information, e.g. RGB data, and depth information, wherein the depth information indicates the third dimension z. Accordingly in that case the 3D image data is internally stored as f(x,y,z(x,y)) Alternatively the 3D image data g(x,y,z) may be stored directly in a 3D addressable storage space. Although the storage space requires an extra dimension the total amount of storage space can still be relatively modest as the resolution in the third dimension representative for the depth does not need to be very high, for example in the order of 8 or 16 in order to give a good impression of the recommended value. The 3D image data may be provided in a compressed or encoded format. For example the 3D image data may be encoded as object-data O(i), wherein each object O(i) represents a content item i. Each content item i may for example correspond to an object O(i) defined by a generic cylinder extruded from the assigned region for the content item i, having a height equal to the assigned depth value and having the image data for the content item projected to its top surface. Accordingly, if the assigned region is shaped as a rectangle, the generic cylinder representing the content item has the form of a block.

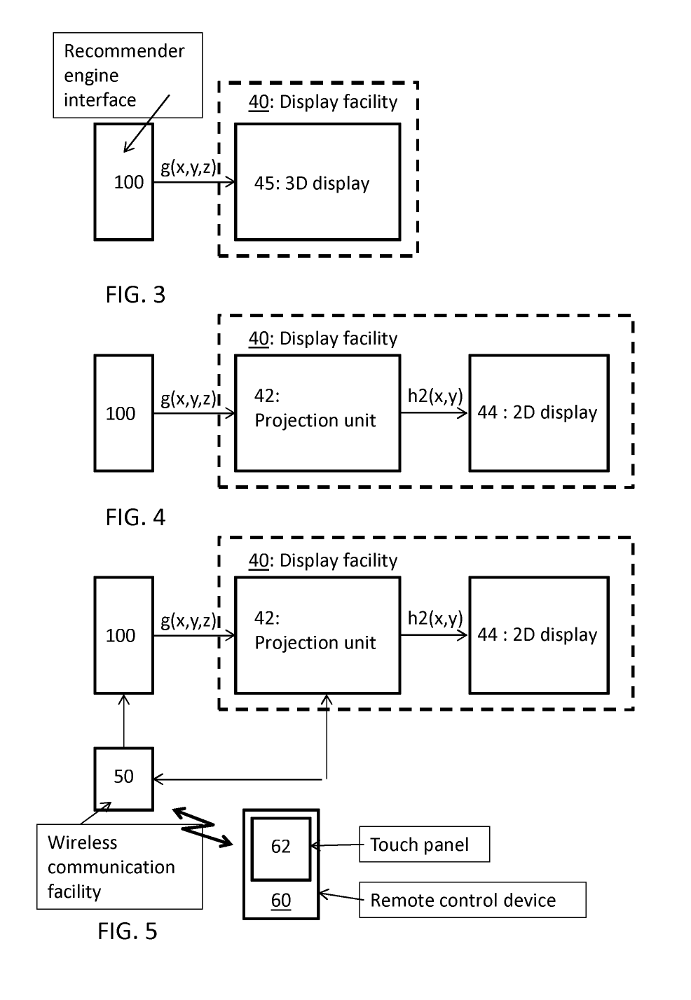

An embodiment of a content delivery system including a recommender engine interface e is now described with reference to FIG. 3. Therein the display facility 40 comprises a three-dimensional display 45 to display the three-dimensional image data g(x,y,z). The display facility 40 may in addition comprise a display processor to decode or decompress the 3D image data and/or to further process the 3D image data, e.g. for changing a point of view, or for enabling control of image settings, e.g. brightness, contrast or a magnification setting for the depth dimension.

The display processor may for example apply a further transformation to display an image function
h3(x,y,z), wherein

h3(x,y,z)=g(X(x,y,z), Y(x,y,z), Z(x,y,z))
Therein X(x,y,z), Y(x,y,z), Z(x,y,z) are obtained by a coordinate transformation.
The coordinate transformation may be a transformation A.

$$( \begin{matrix}X \\ Y \\ Z\end{matrix} ) = A \cdot ( \begin{matrix}x \\ y \\ z\end{matrix} ) ,$$

wherein A is a 3×3 matrix.

Alternatively a homogeneous transformation may be applied.

The viewer may have a control facility (See e.g. element 60 in FIG. 5) to control parameters of the transformation A. The transformation is typically a rotation, allowing perception at different angles, which further supports depth perception, and therewith perception of the recommendation value associated with the displayed content items.

Various options are possible to implement the three-dimensional display 45. According to one option the three-dimensional display is a stereo displays, which presents offset images that are displayed separately to the left and right eye, typically using glasses with complementary coloured filters or complementary oriented polarizing filters. Both of these 2D offset images are then combined in the brain of the viewer to give the perception of 3D depth. The same effect may be obtained with glasses using an active shutter technology. Alternatively the display 45 may be an auto-stereoscopic display. Various other alternatives are possible too, such as volumetric displays and holographic displays.

FIG. 4 shows a part of an alternative embodiment of the content delivery apparatus. Therein the display facility 40 comprises a two-dimensional display 44. The display processor has a projection unit 42. During operation the projection unit 42 projects the three-dimensional image g(x,y,z) to a projection h2(x,y) differing from an orthogonal projection to the first and the second intermediary coordinates (x,y)

Therein h2(x,y)=g(X(x,y,z),Y(x,y,z))

The projection h2(x,y) is then displayed on the two-dimensional display 44. Typically the image h2(x,y) is obtained by a perspective transformation, also denoted as camera transformation. Alternatively, the two-dimensional image h2(x,y) may be obtained from a three-dimensional image h3(x,y,z), which is obtained from g(x,y,z).

In that case h3(x,y,z)=g(X(x,y,z),Y(x,y,z),Z(x,y,z))

FIG. 5 shows an embodiment of the content delivery apparatus that additionally comprises a touch panel 62, here forming part of a remote control device 60. In particular the touch panel 62 is a two-dimensional touch-screen display, which is integrated in a remote control device 60 that communicates with a wireless communication facility 50 of the recommendation system. A dedicated remote control device 60 may be used, but may alternatively the remote control facility may be provided by an application on a handheld mobile device, such as a mobile phone. The touch-screen display 62 enables the viewer to control the recommendation system using the wireless communication link with wireless communication facility 50 of the recommendation system. More in particular the following functions are offered in this embodiment.
a. During operation the display facility 40 displays a selection of the content items from the list of content items. For example the list of content items may be a list of 100 available channels and a selection of 10 channels is displayed by the display facility 40. The remote control device 60 has a first swipe sensing facility for sensing a swiping movement on the touch-screen display 62 in a first direction. In response to a sensed swiping movement, the swipe sensing facility generates a first swipe sense signal that causes the display facility 40 to change the selection in accordance with the swiping movement in said first direction. Preferably the change in selection as a result of the swiping movement is visualized by moving the displayed selection in the same direction as the swiping movement. As a result of this movement part of the previously selected content items are no longer displayed and new content items are added to the selection that is displayed. Alternatively the selection of the content items from the list of content items may be effectuated by the recommender engine interface 100.
b. The remote control device 60 has a second swipe sensing facility for sensing a swiping movement in a second direction. In response to a sensed swiping movement in the second direction, the swipe sensing facility generates a second swipe sense signal. This causes the display facility 40 to change a perspective with which the content items are displayed in accordance with the swiping movement in said second direction. This is achieved in that the projection unit 42 changes the projection h2(x,y) of the image information in the coordinates g(x,y,z) to the two-dimensional space in accordance with the sensed swiping movement. To the viewer this may be apparent in that the displayed selection of content items is tilted in the direction of the swiping movement. Several alternatives are possible for retrieving the list of content items i and the associated recommendation values R(i) for the content items.

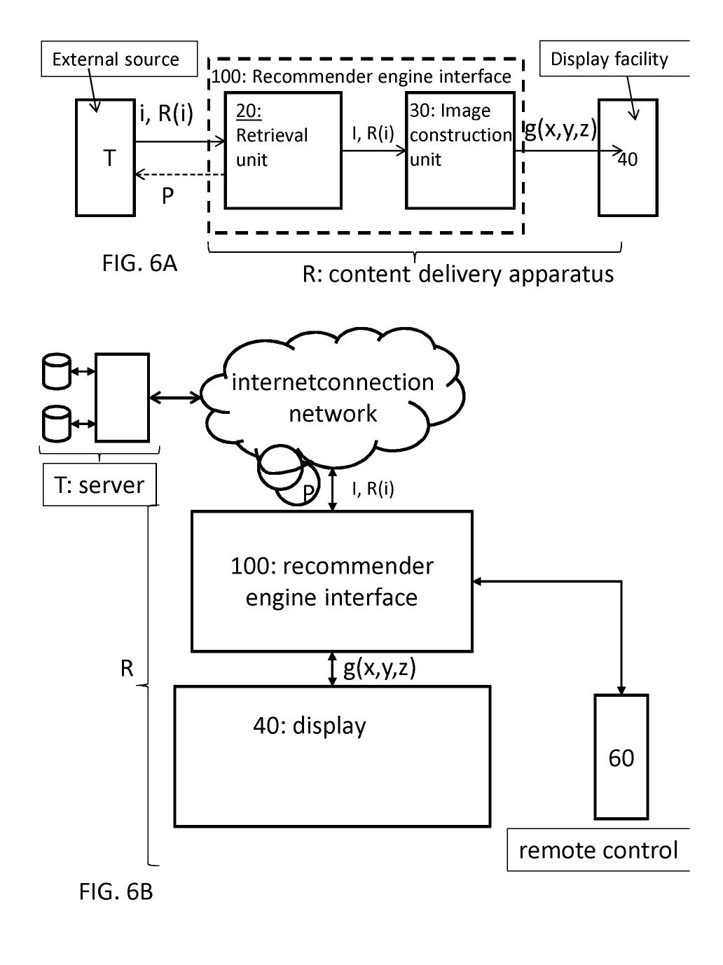

In an embodiment the list of content items (i) and the associated recommendation values R(i) for the content items are provided by an external source T and retrieval unit 20 is arranged to receive the list of content items and their associated recommendation value from the external source T. The retrieval unit 20 may include a network interface for wired or wireless connection to a network, Alternatively the retrieval unit 20 may be a receiver for receiving radio and/or television signals if the external source is a broadcast station. FIG. 6A schematically shows an example of this embodiment. The list of content items (i) is for example a list of movies and the recommendation R(i) may be an average rating of the movies from 1 to 5 stars. In the embodiment shown the recommender engine interface 100 comprises an image construction unit 30 for constructing an image to be delivered. The recommender engine interface 100 is coupled to a display facility 40 for displaying the constructed image delivered by the recommender engine interface 100. The content delivery system R shown in FIG. 6A may be a digital television system, but may alternatively be a personal computing device, a telephone, or a tablet for example.

FIG. 6B shows a recommender engine interface 100 that uses information from a remote server T about the items that can be recommended. To that end the remote server T is provided with a recommender. The latter has learned the user's preferences through the interaction that the user has had with the recommender via e.g. the UI of a mobile phone, a remote control, etc. Based on the user's preferences the recommender provides its recommendations and the recommender engine interface generates true 3D images, or pseudo 3D images, where the depth (z coordinate) at which each of the items is shown in the images indicates the score that the recommender engine assigned to the specific item. These displayable images are next displayed on a preferably true 3D screen. This could be a TV, the display of a mobile phone, tablet, watch, PC, etc.

The image information may for example be represented as a grid having a first axis in the direction of the first intermediate coordinate x that indicates a movie category and a second axis in the direction of the second intermediate coordinate y that indicates a time at which the movie is broadcasted. In this way a first partitioning and a second partitioning of space defined by the intermediary coordinates is achieved, wherein the first and the second partitioning respectively partition the space in the direction of the first intermediate coordinate x and the second intermediate coordinate y, respectively according to a first and a second property of the content items i.

The movie category is for example the IMDB genre indication comprising the genres Action, Adventure, Animation, Biography, Comedy, Crime, Documentary, Drama, Family, Fantasy, Film-Noir, Game-Show, History, Horror, Music, Musical, Mystery, News, Reality-TV, Romance, Sci-Fi, Sport, Talk-Show, Thriller, War and Western. Even if the recommendation is based on ratings given by the average viewer, a particular user can still select a favourable category and subsequently select a recommended movie within that category.

Alternatively, the recommendations as retrieved by the retrieval unit 20 may take into account personal preferences. The personal preferences may be entered by the user him/herself and/or may be derived automatically from actual user behaviour. A method for automatically generating a user profile is disclosed for example in WO2007063463 filed by the same Applicant

In this case, the retrieval unit 20 may calculate the recommendation value R(i) for a content item (i) on the basis of the features of the content item and the relevance given by the user to those features. Features of a content item are preferably provided as metadata. Examples are names of the actors, name of the director etc. Alternatively or additionally, features may be derived from the content, for example by recognizing and analysing audible content, e.g. speech or music and/or recognizing and analysing visual content, e.g. closed captions. WO2012023091 filed by the same applicant indicates how a recommendation is determined and how the user can control this process.

In the embodiment shown in FIG. 6A, 6B, an uplink connection (indicated by a dashed arrow in FIG. 6A and the backwards portion of the bidirectional arrow in FIG. 6B) may be available to provide the source T with personal preferences P of the user, therewith enabling the source T to refine the recommendation R(i) for items i on the basis of this personal information. Alternatively, a user profile with personal preferences may be stored locally in the content delivery system R. In that case the retrieval unit 20 may retrieve the recommendations R(i) for items i on the basis of features specified for the items provided by the source T and the personal information maintained by the content delivery system R.

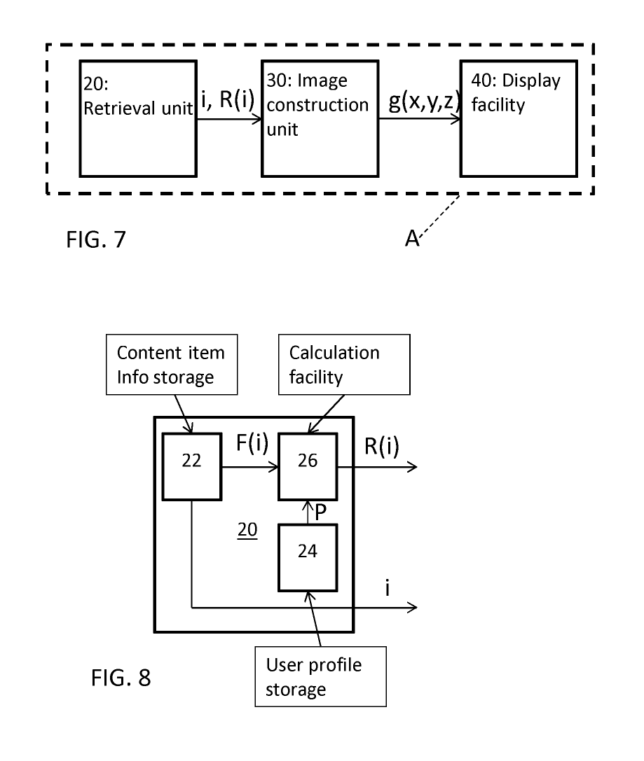

In again another embodiment as illustrated in FIG. 7 the content delivery system A is a stand-alone device, such as a user appliance A, such as a media reproduction device. In this case the retrieval unit 20 of the content delivery system retrieves the recommendation values R(i) for the content items i from an internal source. An example of a retrieval unit 20 suitable for this purpose is shown in some more detail in FIG. 8

As shown in FIG. 8, the recommendation facility 20 includes a storage facility 22 providing for content item information storage, a storage facility 24 providing for a user profile storage, and a calculation facility 26. The storage facility 22 stores content items i as well as information about features F(i) for said respective content items. The storage facility 24 stores user profile information P and the calculation facility calculates a recommendation value for each content item i on the basis of the features F(i) for said content item and the value P of those features for the user. It is noted that the storage facilities facilities 22, 24 may be storage spaces in physically different memory devices, but may alternatively be respective storage spaces in a shared memory device.

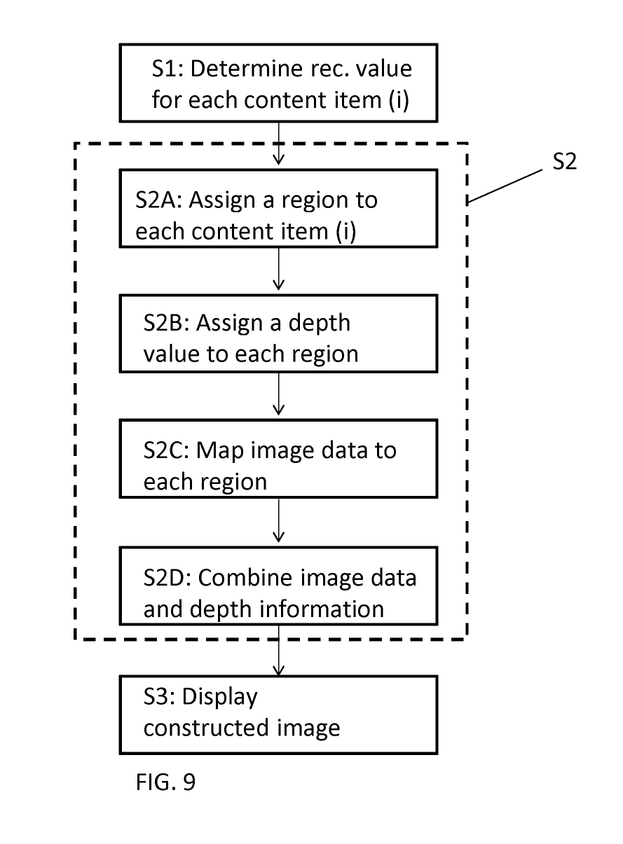

FIG. 9 schematically shows a method according to the third aspect of the invention for recommending content items that comprises the following steps.

In a first step S1 a respective recommendation value is determined for each content item. The recommendation value may be based on a personal profile or based on generally accepted criteria.

In a second step S2 an image is constructed, for example in a storage facility. The image has image information (g) as a function of a first, a second and a third intermediary coordinate (x,yz). This involves the following sub steps.

In a first sub-step S2A of the second step S2 a respective region is assigned to each content item in a space defined by the intermediate coordinates (x,y).

In a second sub-step S2B of the second step S2 each region is assigned a depth value for said third intermediate coordinate. The depth value corresponds to the recommendation value for the content item corresponding to said region. The depth value assigned to the region may be stored in a memory location for each coordinate (x,y) forming part of said region. Alternatively, each region may have a single respective storage location. In that case the depth value for a position (x,y) can be retrieved by first determining the region that corresponds to that position, and by subsequently reading the depth value from the location corresponding to said region.

In a third sub-step S2C of the second step S2 respective image information is mapped to each region. The mapped image information is the image information of the content item corresponding to said region.

In a fourth sub-step S2D the respective image data f(i) and respective depth value d(i) for the regions assigned to the content items in the subset is combined into three-dimensional image data g(x,y,z).

In a third step S3 the so constructed image is displayed.

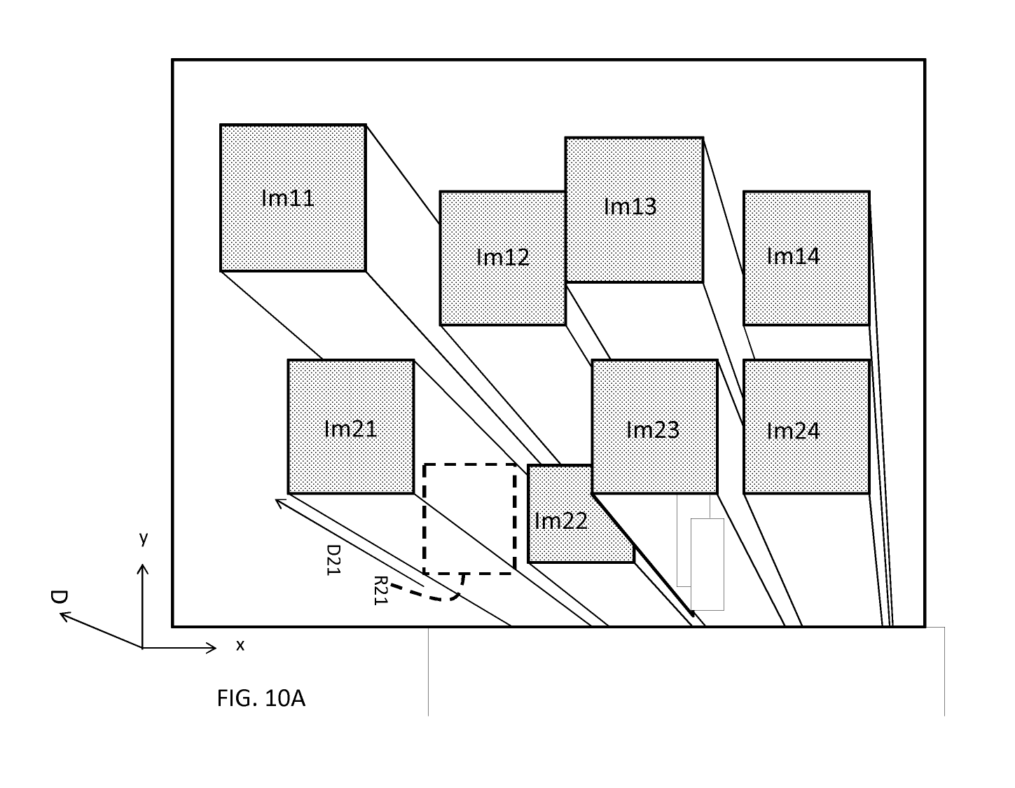

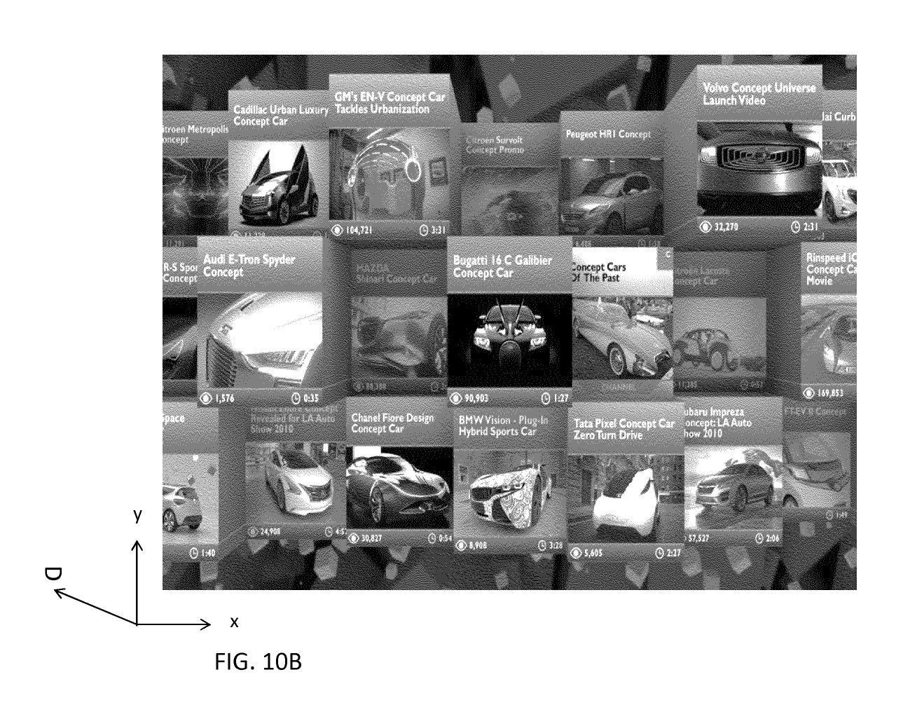

FIGS. 10A and 10B show an application of the recommendation system and the method for recommending content items according to the present invention. Therein FIG. 10A is a schematic representation and FIG. 10B shows an actual implementation in an environment relating to car models.

FIG. 10A schematically shows an exemplary output of a two-dimensional display facility in an embodiment of an apparatus including a recommender engine interface as shown in FIG. 4 or FIG. 5. By way of example a recommendation value is shown for a selection of 8 content items. In this case it is presumed that a combining module 39 (See e.g. FIG. 2) is applied that constructs respective three-dimensional objects for the content items in the subset from their mapped image data and assigned depth value. In particular the constructed objects are generalized cylinders having the assigned region of the content items as an end-face and having a length corresponding to the assigned depth value. In this case the assigned regions are rectangles and accordingly the corresponding cylinders are blocks. Furthermore, the corresponding image data Im11, Im12, Im13, Im14; Im21, Im22, Im23 and Im24 is mapped to the opposite end-face visible to the user. The identity of the content item is indicated by its corresponding image data in the region. Although the 2D display is not capable of providing the true depth information f(x,y,z) as provided by the combination unit 39 the projection unit 42 provides for a projection h2(x,y) that provides the user with sufficient clues to quickly recognize the most recommended items. By way of example R21 is indicated as the region for content item 21. The latter has an associated depth value D=D21. From the side faces of the objects it can for example be seen that the object for content item 11 having the mapped image data Im11 extends clearly beyond the object for content item 21 having the mapped image data Im21. The viewer will therewith intuitively recognize that content item 11 is more recommended than content item 21. As another example it can be seen that the content item 22 being represented as the object with mapped image data Im22 has a low recommendation as compared to the other content items, as its object is even partly hidden by the object having mapped image data Im23 of content item 23. As also becomes apparent from these examples, the more recommended content items are generally better visual than the less recommended content items.

In the actual implementation shown in FIG. 10B, the content items in the list of content items includes a list of car models, some of which are shown in the first column of the following table.

The second column of the table shows the recommendation value assigned to content items in the list. The recommendation value RVAL that is assigned to the content items in the list may be obtained in various ways. For example viewers may be asked to vote. The number of votes so obtained for each model may serve as a recommendation value for others. Alternatively, a personalized recommendation value may be calculated on the basis of criteria provided by a user. A user may for example specify personal requirements to a number of parameters, such as size, fuel consumption, maximum speed, etc. On the basis of this personal information it can be determined to what extent a particular model can be recommended to the user for complying with these personal requirements.

The third column indicates the region which is assigned to each content item. In this case the regions are arranged according to a pattern of rows and columns. In this example the four content items shown in the table below are assigned the regions on the first row, in columns 20-23 respectively. As can be seen in FIG. 10, further content items are displayed in the second and the third rows. Also further content items are available in columns 1 to 19 and 23 and upwards. The content items in the columns 19 and 24 are partly shown.

The fourth column indicates an address A1, A2 etc., from which image information to be mapped to the storage facility 10 can be retrieved.

TABLE 1
Example of content items and related features

| Content item | RVAL | region | Image |
|---|---|---|---|
| Cadillac Urban Luxury | 6 | (1, 20) | A1 |
| GM's EN-V | 8 | (1, 21) | A2 |
| Citroen Survolt | 1 | (1, 22) | A3 |
| Peugeot HRI | 4 | (1, 23) | A4 |
| . . . | | | |

As becomes apparent from FIG. 10B, content items having a high recommendation value RVAL, such as the Audi E-Tron Spyder and Volvo Concept Universe are represented at an apparent proximity to the viewer. This is achieved in that a depth value z is assigned to each region that corresponds to the recommendation value RVAL for the content item to which said region is assigned. From this information a three-dimensional representation g(x,y,z) of the image is obtained for example as illustrated in FIG. 4. Subsequently, a two-dimensional projection h2(x,y) is generated differing from an orthogonal projection on the coordinates (x,y). In this case this is achieved by a perspective transformation. This is also denoted as a “camera transformation” as it results in an image similar to that of a three-dimensional object captured by a camera. In the embodiment shown, the images representing the content items are shown as if they are mapped on a box protruding in the depth direction from the assigned region. The visibility of the upstanding walls of the boxes corresponding to the more recommended content items provides an additional depth clue to the viewer, despite the fact that the display is of a two-dimensional type. A further depth clue is given in that images of content items having a relatively high recommendation value RVAL are displayed with a relatively high brightness as compared to images of content items having a relatively low recommendation value. In particular the brightness difference in the titles corresponding to the images contribute to this depth clue, as the depth value here is the only factor that determines the brightness.

In the recommender engine interface of FIG. 5 a further depth clue is provided in that the viewer can change the point of view of the perspective transformation, by using the second swipe sensing facility of the touch-panel 62 integrated in remote control 60. I.e. by swiping in the y-direction the point of view also changes according to that direction. In this way for example, the lower side-wall of the box with the content item “Bugatti 16 C Galibier” becomes visible, so that the viewer can get a more accurate impression of the difference in recommendation value as compared to the model “BMW Vision—Plug in Hybrid Sports Car” presented below.

In the present example the first swiping facility can be used to select other content items for display. For example, by swiping from left to right in the x-direction, content items assigned to regions in the lower numbered columns become visible, and by swiping from right to left in the x-direction, content items assigned to regions in the higher numbered columns become visible.

Alternatively, if only a limited number of content items is available, it may be not necessary to select content items for display, using the first swiping facility. In this case, the first swiping facility may be used to also change the point of view in the x-direction.

Although embodiments of the present invention have been illustrated in the accompanying drawings and described in the foregoing detailed description, it will be understood that the invention is not limited to the embodiment disclosed, but is capable of numerous modifications without departing from the scope of the invention as set out in the following claims.

‘Means’, as will be apparent to a person skilled in the art, are meant to include any hardware (such as separate or integrated circuits or electronic elements) or software (such as programs or parts of programs) which reproduce in operation or are designed to reproduce a specified function, be it solely or in conjunction with other functions, be it in isolation or in co-operation with other elements. The invention can be implemented by means of hardware comprising several distinct elements, and by means of a suitably programmed computer. In the apparatus claim enumerating several means, several of these means can be embodied by one and the same item of hardware. ‘Computer program product’ is to be understood to mean any software product stored on a computer-readable medium, such as a floppy disk, downloadable via a network, such as the Internet, or marketable in any other manner.

In the claims the word “comprising” does not exclude other elements or steps, and the indefinite article “a” or “an” does not exclude a plurality. A single component or other unit may fulfill the functions of several items recited in the claims. The mere fact that certain measures are recited in mutually different claims does not indicate that a combination of these measures cannot be used to advantage. Any reference signs in the claims should not be construed as limiting the scope.

1. A recommender engine interface, comprising:
a retrieval unit to retrieve a list of content items and an associated recommendation value;
an image construction unit to construct an image, the image having an image value as a function of a first and a second intermediary coordinates, wherein the image construction unit includes:
a region assignation module configured to assign to at least a subset of content items in said list a respective region in a space defined by the first and the second intermediate coordinates;
a depth assignation module configured to assign to each region a respective depth value for a third intermediate coordinate, the depth value corresponding to the recommendation value for the content item to which said region is assigned;
an image mapping module configured to map to each region respective image data of the content item to which said region is assigned: and
a combining module configured to combine said respective image data and said respective depth value for the regions assigned to the content items in said subset into three-dimensional image data suitable to be provided to a display facility.

2. The recommender engine interface according to claim 1, wherein the respective regions are obtained by a first partitioning and a second partitioning of space defined by the first and the second intermediary coordinates, wherein the first and the second partitioning respectively partition the space in the direction of the first intermediate coordinate and the second intermediate coordinate, respectively, according to a first and a second property of the content items.

3. A content delivery apparatus, comprising:
a recommender engine interface comprising:
a retrieval unit to retrieve a list of content items and an associated recommendation value;
an image construction unit to construct an image, the image having an image value as a function of a first and a second intermediary coordinates, wherein the image construction unit includes;
a region assignation module configured to assign to at least a subset of content items in said list a respective region in a space defined by the first and the second intermediate coordinates;
a depth assignation module configured to assign to each region a respective depth value for a third intermediate coordinate, the depth value corresponding to the recommendation value for the content item to which said region is assigned;
an image mapping module configured to map to each region respective image data of the content item to which said region is assigned; and
a combining module configured to combine said respective image data and said respective depth value for the regions assigned to the content items in said subset into three-dimensional image data; and
a display facility for displaying the constructed image wherein the retrieval unit is configured to retrieve the list of content items and their associated recommendation value from an external source.

4. The content delivery apparatus according to claim 3 wherein the retrieval unit is configured to retrieve the list of content items and their associated recommendation value from an internal source.

5. The content delivery apparatus according to claim 3, wherein the display facility comprises a three-dimensional display to display the three-dimensional image data.

6. The content delivery apparatus according to claim 3, wherein the display facility comprises a two-dimensional display, the display facility further comprising a projection unit to project the three-dimensional image data to a projection.

7. The content delivery apparatus according to claim 3, wherein content items having a neutral recommendation value are displayed in said depth dimension at a position corresponding to a surrounding frame.

8. The content delivery apparatus according to claim 3, comprising a touch panel, wherein said touch panel is a two-dimensional touch-screen display.

9. (canceled)

10. The content delivery apparatus according to claim 3, wherein the display facility in an operational mode displays a selection of the content items from the list of content items, and wherein the content delivery apparatus has a selection control facility that generates a selection control signal in response to a sensed user input indicative for a desired change in selection, and wherein the selection control signal causes the content delivery apparatus to change the selection in accordance with the sensed user input.

11. The content delivery apparatus according to claim 3, further comprising a view control facility that generates a view control signal in response to a sensed user input indicative for a desired change in a perspective with which the content items are displayed, the view control signal causing the display facility to change a perspective with which the content items are displayed in accordance with the sensed user input.

12. The content delivery apparatus according to claim 3, further comprising a storage facility for storing a user profile, wherein the user profile comprises values associated by a user to content item features, the retrieval unit determining a recommendation value in accordance with the content item features present in the content items and the values associated therewith by the user.

13. A method for visualizing a recommendation of content items comprising:
retrieving a respective recommendation value for each content item;
constructing an image having image information as a function of a first and a second intermediary coordinate;
assigning to at least a subset of content items in said list a respective region in a space defined by said first and second intermediate coordinates;
assigning to each region a respective depth value for a third intermediate coordinate, the depth value corresponding to the recommendation value for the content item corresponding to said region;
mapping, for each region, respective image information of the content item corresponding to said region,
combining said respective image information and said respective depth value for the regions assigned to the content items in said subset into three-dimensional image data; and
displaying the three-dimensional image data.

14. The method according to claim 13, wherein the three-dimensional image data is displayed on a three-dimensional display.

15. The method according to claim 13, further comprising projecting the three-dimensional image data to a two-dimensional space differing from the two-dimensional space defined by the first and the second intermediary coordinates and displaying the projected image.

16. A non-transitory computer-readable medium having one or more executable instructions stored thereon, which when executed by a processor, cause the processor to perform a method for visualizing a recommendation of content items, the method comprising:
retrieving a respective recommendation value for each content item;
constructing an image having image information as a function of a first and a second intermediary coordinate;
assigning to at least a subset of content items in said list a respective region in a space defined by said first and second intermediate coordinates;
assigning to each region a respective depth value for a third intermediate coordinate, the depth value corresponding to the recommendation value for the content item corresponding to said region;
mapping, for each region, respective image information of the content item corresponding to said region;
combining said respective image information and said respective depth value for the regions assigned to the content items in said subset into three-dimensional image data; and
displaying the three-dimensional image data.

17. The recommender engine interface according to claim 1, wherein the three-dimensional image data is encoded as object-data comprising a respective object representing each content item, wherein each object is defined by a respective generalized cylinder having a length corresponding to said respective depth value for the region assigned to the respective content item, wherein an end-face of said respective generalized cylinder is the region assigned to the respective content item, and wherein the respective image data of the respective content item is mapped onto an opposite end-face of said respective generalized cylinder.

18. The method according to claim 13, further comprising encoding the three-dimensional image data as object-data comprising a respective object representing each content item, wherein each object is defined by a respective generalized cylinder having a length corresponding to said respective depth value for the region assigned to the respective content item, wherein an end-face of said respective generalized cylinder is the region assigned to the respective content item, wherein the respective image data of the respective content item is mapped onto an opposite end-face of said respective generalized cylinder.
